(19) United States
(12) Patent Application Publication
(10) Pub. No.: US 2007/0263154 A1
(43) Pub. Date: Nov. 15, 2007

(54) DISPLAY UNIT INCLUDING AN ANTIDAZZLING FILM

(76) Inventor: Teruaki SUZUKI, Kawasaki (JP)

Correspondence Address: HAYES SOLOWAY P.C., 3450 E. SUNRISE DRIVE, SUITE 140, TUCSON, AZ, 85718, US

(21) Appl. No.: 11/746,615

(22) Filed: May 9, 2007

(30) Foreign Application Priority Data
May 12, 2006 (JP) 2006-134334

(51) Int. Cl. G02F 1/1335

(52) U.S. Cl. 349/137

(57) ABSTRACT

A display unit includes an antidazzle film having anisotropy with respect to the azimuth direction of the incident light incident onto the antidazzle film in a slanted direction slanted in the azimuth direction. The display panel has anisotropy with respect to the azimuth direction of the slanted view. The antidazzle film has a lower light scattering function wither respect to the azimuth direction in which the amount of leakage light is smaller, to suppress reduction in the contrast ratio.

This application is based upon and claims the benefit of priority from Japanese patent application No. 2006-134334 filed on May 12, 2006, the disclosure of which is incorporated herein in its entirety by reference.

### BACKGROUND OF THE INVENTION

1. Field of the Invention

The present invention relates to a display unit including an antidazzle film, and a method of manufacturing the same. More particularly, the present invention relates to a display unit including an antidazzle film for suppressing the decrease in the visibility of images due to the interference of incident light with the external light, and a method for manufacturing the display unit. The present invention also relates to a polarizing film and an antidazzle film for use in such a display unit.

2. Description of the Related Art

Most liquid crystal display units (LCD units) hare the advantage of smaller thickness, smaller weight and lower power dissipation. Of a variety of modes of LCD units, active-matrix-mode LCD (AM-LCD) units, in which active elements such as a switching device drive an array of pixels, are recognized as superior flat-panel display units capable of achieving a high-image quality. Of AM-LCD units, thin-film-transistor LCD unit TFT-LCD) are widely used, in which thin-film transistors (TFTs) are provided as active elements for controlling the pixels. In recent years, the pixels have smaller and smaller dimensions to realize a higher resolution.

The liquid crystal (LC) driving mode used in most of the AM-LCD units is a twisted-nematic (TN) mode in which an electric field is applied to the liquid crystal layer including LC molecules in a twisted orientation between a pair of transparent substrates. The electric field is applied to the LC molecules in a direction substantially perpendicular to the substrates. Some other LC driving modes are also used heretofore, which enable the LCD units to achieve a higher image quality. Examples of such LC driving mode or scheme include: a vertical orientation scheme in which the LC molecules are vertically aligned to have a homeotropic orientation or vertical orientation between the substrates; a bend orientation scheme in which the LC molecules are arched by deformation to have a bend orientation between the substrates; and in-plane switching mode in which a horizontal electric field substantially parallel to the substrate surface is applied to the LC molecules to have a homogenous orientation between the substrate, all for achieving the higher image quality.

In the LCD unit using any one of the LC driving modes as specified above, a LC cell including a pair of substrates sandwiching therebetween a LC layer, and a pair of polarizing films sandwiching therebetween the LCD cell are disposed in front of a light source (backlight), and the LC cell is applied with an electric field for achieving the image display, in the view point of optical function thereof. The electric field applied to the LC cell controls the polarization of the light emitted from the light source and passing through the LC cell, thereby controlling the transmission of the light through the polarization film. The polarizing films generally have a shape of thin sheet, and bonded onto the outer surface of the substrates sandwiching therebetween the LC layer. In an alternative, the polarizing films may be bonded onto the inner surface of the substrates, and are thus referred to as in-cell polarizing films.

Another type of the LCD unit, referred to as reflection LCD unit, in which external light incident onto and passed by the LC layer is reflected to pass through the LC layer again, uses a single polarizing film. Other types of the LCD unit are also known which do not include a polarizing film, operating in a guest-host mode or cholesteric LC driving mode.

Before conceiving the present invention, the inventor analyzed a desired LCD device which can suppress glare light on the display screen and yet suppress reduction in the visibility of the image, as detailed hereinafter.

In most ordinary display units including the LCD units as described above, an antidazzle film is provided on the display screen in order to suppress the glare light and improves the visibility of images degraded due to the interference of the internal light with the external light passing through room windows or emitted by indoor illumination devices. Patent Publications JP-1994-18706A and IP-1998-20103A, for example, describe an antidazzle film including a transparent base layer and an antidazzle layer formed on the base layer and having a concave-and-convex surface.

A variety of types of antidazzle film are available. One type has a transparent base layer coated, on a surface thereof, with resin including bead particles, to have convex portions and concave portions on the surface. Another type has a plurality of films having a concave-and-convex surface and layered on one another to transfer the surface configuration toward the upper layer. In any types of the antidazzle film described in JP-1994-18706A and JP-1998-20103A, the antidazzle function is attained only by the external concave-and-convex surface. To enhance the antidazzle function, a larger difference in the height between the concave portions and convex portions is desired, if the difference in the height between the concave portions and convex portions is excessively large, however, the haze value which is defined by the ratio of the transmittance of the scattering light to the transmittance of the total light will increase. This increase inevitably degrades the definition of images on the display screen.

The antidazzle film may be used in a high-definition display unit. In this case, glare light colored at random, known as scintillation, will develop to reduce the visibility of the image on the display screen. This undesirable phenomenon occurs because specific pixels located at the focal point of the lens defined by the radii of curvature of the concave and convex portions of the antidazzle film will look very bright due to the interference between the pitch of the pixels and the pitch of the concave-and-convex surface of the antidazzle film Patent Publication JP-2001-91707A describes the combination of an antidazzle film having a concave-and-convex surface and an underlying scattering film including therein fine particles for scattering the incident light. In this configuration, the underlying scattering film can prevent the light from passing straight within the layer, to thereby suppress occurring of the scintillation.

The technique described in JP-2001-91707A has also a problem that should be solved. If the antidazzle film described in JP-2001-91707A is used in a display unit from which the light leaks in a slanted direction upon display of the dark state on the display screen, part of the leakage light will have a traveling direction changed toward the front direction, due to the function of the underlying scattering film. Consequently, the contrast in the front direction will decrease. To solve this problem, the technique described in Patent Publication JP-2003-202416A may be employed. JP-2003-202416A describes a combination of an underlying scattering film and an antidazzle film, the underlying scattering film including a transparent matrix and a transparent material dispersed in the matrix. The antidazzle film has a concave-and-convex surface. The material dispersed therein has a refractive index different from that of the transparent matrix and an anisotropic light scattering function caused by the anisotropic shape thereof. Further, the material is dispersed in the transparent matrix, substantially in parallel to the direction normal to the film.

The underlying scattering film used in combination with the antidazzle film, as described in JP-2003-202416A, has an anisotropic light scattering function, exhibiting anisotropy with respect to the angle at which the light is incident thereto. More specifically, the scattering film strongly scatters the light incident thereto in the normal direction and yet weakly scatters the light incident thereto in a slanted direction is means the light is emitted therefrom mostly as parallel light beams, because the light incident thereto in a slanted direction is scarcely scattered. That is, the light incident in the slanted direction is scarcely changed to the normal direction in the case of the configuration described in JP-2003-202416A. Hence, the decrease in the front contrast ratio is suppressed even if the underlying scattering film is used to prevent the scintillation.

FIG. 14 shows how the contrast ratio depends on the viewing angle in a LCD unit of the in-plane switching mode. As an example of the display unit from which light leaks in a slanted direction upon display of the dark state, a TFT-LCD unit of the in-plane switching mode, which includes therein no antidazzle film on the display screen, was tested for examining the contrast ratio of such a display unit. In this test, the ratio of the luminance upon display of the bright state (brightest state) to the luminance upon display of the dark state (dark state) was measured at a variety of viewing angles in order to determine the dependency of the contrast ratio on the viewing angle. FIG. 14 shows the results thus obtained. It is to be noted that the LCD unit used for the test has a pair of polarizing films having optical axes intersecting each other at right angles, wherein the optical axis of one of the polarizing films is shown at 0 degree whereas the optical axis of the other the polarizing films is shown at 90 degrees. The term optical axis as used herein means either a light absorption axis or a light transmission axis for both the polarizing films.

Of a variety of LC driving modes for the LCD unit, the in-plane switching mode is generally considered superior to other modes in the viewing angle characteristic. Even in the in-plane switching mode, however, the contrast ratio attained as viewed in a direction slanted from the front direction, or normal direction, is smaller than the contrast ratio attained as viewed in the front direction, or normal direction. This will be understood from FIG. 14, wherein the amount of leakage light in the slanted direction upon display of the dark state is larger than the amount of leakage light in the front direction upon display of the dark state.

If the antidazzle film described in JP-2003-202416A is used in such a LCD unit, only a small part of the leakage light in the slanted direction upon display of the dark state is directed toward the normal direction, unlike in the case where the antidazzle film described in JP-2001-91707A is used. Hence, use of the antidazzle film described in JP-2003-202416A can suppress the decrease in the contrast ratio in the normal direction.

Analyzing FIG. 14 in detail, it is found that the change in the contrast ratio depends on the azimuth direction in which the image on the LCD unit is observed. More specifically, the contrast ratio decreases only in a small amount depending on the viewing angle when observed in an azimuth direction of 0 degree (or 180 degrees), i.e., observed parallel to the light absorption axis of the polarizing layer and in another azimuth direction of 90 degrees (or 270 degrees), i.e., observed parallel to the light transmission axis of the polarizing layer. On the other hand, the contrast ratio significantly decreases depending on the viewing angle, in the direction of 45 degrees (or 225 degrees), deviated by 45 degrees from the light absorption axis of the polarizing layer and in the direction of 135 degrees (or 135 degree), deviated by 45 degrees from the light transmission axis of the polarizing layer. This means: the amount of leakage light upon display of the dark state scarcely changes in the direction parallel to the light absorption or light transmission axis of the polarizing film, and significantly changes in the direction deviated by 45 degree from the light absorption or light transmission axis of the polarizing film.

As described above, the underlying scattering film described in JP-2003-202416A exhibits anisotropy with respect to the incidence angle of the light. More precisely, the underlying scattering layer significantly scatters the incident light incident thereto in the normal direction and scarcely scatters the incident light incident thereto in a slanted direction. Although the underlying scattering film has anisotropy with respect to the incidence angle, it exhibits isotropy with respect to the azimuth direction of the incident light. If the underlying scattering film is used in a LCD unit of the type in which the amount of leakage light in a slanted viewing direction upon display of the dark state depends on the azimuth direction as shown in FIG. 14, the contrast ratio in the normal direction may decrease, because the traveling direction of the light incident to the underlying scattering film is changed to the normal direction from the direction in which the amount of leakage light is larger. Thus, the configuration described in JP-2003-202416A will not perform the function to the extent desired herein.

### SUMMARY OF THE INVENTION

It is an object of the present invention to provide a display unit having an antidazzle film and capable of suppressing the reduction in the contrast ratio caused by the antidazzle film.

The present invention providers, in a first aspect thereof, a display unit comprising: a display panel having a property wherein an amount of leakage light upon display of a dark state is smaller in a slanted view slanted in a first azimuth direction than in a slanted view slanted in another azimuth direction; and an antidazzle film that scatters incident light and has a higher scattering function with respect to light incident in a second azimuth direction than with respect to light incident in another azimuth direction, wherein said first azimuth direction substantially coincides with said second azimuth direction.

The present invention provides, in a second aspect thereof, an optical polarization film comprising: a polarizing layer having a light transmission axis and a light absorbing axis perpendicular to one another: and an antidazzle film that scatters incident light and has a higher scattering function with respect to light incident in a first azimuth direction than with respect to light incident in another azimuth direction, wherein the first azimuth direction substantially coincides with the light transmission axis or the light absorbing axis.

The present invention provides, in a third aspect thereof, an antidazzle film including: a scattering control film having anisotropy with respect to an azimuth direction of incident light; and a surface scattering film having a concave-and-convex surface, wherein the antidazzle film has a higher scattering function with respect to light incident in an azimuth direction than with respect to light incident in another azimuth direction.

The present invention provides, in a fourth aspect thereof, a method for manufacturing an antidazzle film, including: transferring a pattern having concave portions and convex portions onto a film by using an embossing technique to form the antidazzle film having concave portions and convex portions, the concave portions and/or the convex portions having anisotropy in the shape thereof.

The present invention provides, in a fifth aspect thereof, a method for manufacturing an antidazzle film, including: forming a photoresist film on a base film, exposing the photoresist film by using an exposure mask, and developing the exposed photoresist film, to form the antidazzle film having concave portions and convex portions, the concave portions and/or the convex portions having anisotropy in the shape thereof.

The present invention provides, in a sixth aspect thereof, a method for manufacturing an antidazzle film, including: forming a photoresist film on a base film, exposing the photoresist film by using an exposure mask, developing the exposed photoresist film, and melting the developed photoresist film, to form the antidazzle film having concave portions and convex portions, the concave portions and/or the convex portions having anisotropy in the shape thereof.

The above and other objects, features and advantages of the present invention will be more apparent from the following description, referring to the accompanying drawings.

### BRIEF DESCRIPTION OF THE DRAWINGS

FIG. 1 is a perspective view showing a display unit according to an exemplary embodiment of the present invention;

FIG. 2A is a perspective view of the display panel in the display unit of FIG. 1, showing the azimuth direction dependency of the leakage light;

FIG. 2B is a top plan view of the display panel, illustrating the azimuth direction shown in FIG. 2A;

FIG. 3A is a perspective view of the display panel in the display unit, showing the azimuth direction dependency of the scattering of light;

FIG. 3B is a top plan view of the display panel, illustrating the azimuth direction shown in FIG. 2A;

FIG. 4A is a perspective view of the antidazzle film used in the display unit of FIG. 1, showing the azimuth direction dependency of the scattering of light;

FIG. 4B is a top plan view of the antidazzle film, illustrating the azimuth direction shown in FIG. FIG. 4A;

FIG. 5A is a perspective view of the antidazzle film used in the display unit of FIG. 1, showing the azimuth direction dependency of the scattering of light;

FIG. 5B is a top plan view of the antidazzle film, illustrating the azimuth direction shown in FIG. 5A;

FIG. 6 is a perspective view of a display unit according to a first exemplary embodiment of the present invention;

FIG. 7 is an exploded perspective view of the display unit of FIG. 6;

FIG. 8 is a schematic perspective view showing the scattering of light by the scattering control film shown in FIG. 7;

FIG. 9 is another schematic perspective view showing the scattering of light by another scattering control film shown in FIG. 7;

FIG. 10 is a perspective view of a display unit according to a second exemplary embodiment of the present invention;

FIG. 11 is an exploded perspective view of the display unit of FIG. 10;

FIG. 12 is a top plan view of the surface scattering film shown in FIG. 11, illustrating the detail of a portion of the surface scattering film;

FIGS. 13A to 13C are top plan views showing different examples of the pattern for the surface scattering film; and

FIG. 14 is a graph representing the azimuth angle dependency of the contrast ratio in a typical IPS-mode LCD device

### DETAILED DESCRIPTION OF THE PREFERRED EMBODIMENTS

Now, exemplary embodiments of the present invention will be described with reference to accompanying drawings, wherein similar constituent elements are designated by similar reference numerals throughout the drawings.

FIG. 1 is a perspective view of a display unit according to an embodiment of the display invention. The display unit 100 has a display panel 110 and an antidazzle film 120 formed thereon, and displays images on the front screen. The antidazzle film 120 suppresses the decrease in the visibility of images on the display screen due to the interference of the internal light with the external light. The antidazzle film 120 is bonded onto the front surface of the display panel 110, i.e., the display screen. As shown in FIG. 1, the direction in which the longer sides (horizontal sides) of the display screen extend is referred to as x-direction, and the direction in which the shorter sides (vertical sides) of the display screen extend is referred to as y-direction. For the sake of convenience, the antidazzle film 120 is assumed here as a component bonded onto the display panel 110. Nonetheless, no antidazzle film may be bonded onto the display panel 110, and the front surface of the display panel 110 may be treated to have an antidazzle property.

The display characteristic of the display panel 110 depends on the viewing angle. The amount or intensity of the leakage light depends on the slanted direction, i.e., the direction in which the image is observed with respect to the direction normal to the display screen, or front direction, and also especially depends on the azimuth direction. The antidazzle film 120 passes therethrough the light emitted from the display panel 110 toward the observer observing the display screen. The antidazzle film 120 has a light scattering function, which depends on the direction of the incident light. More particularly, with respect to the light incident onto the antidazzle film 120 in a slanted direction, the degree of the scattering depends on the azimuth direction of the incident light. In the present embodiment, the antidazzle film 120 is stacked onto the display panel 110 so that the azimuth direction in which a smallest amount of leakage light is observed in a slanted view coincides with the azimuth direction in which the antidazzle film 120 has a strong scattering function.

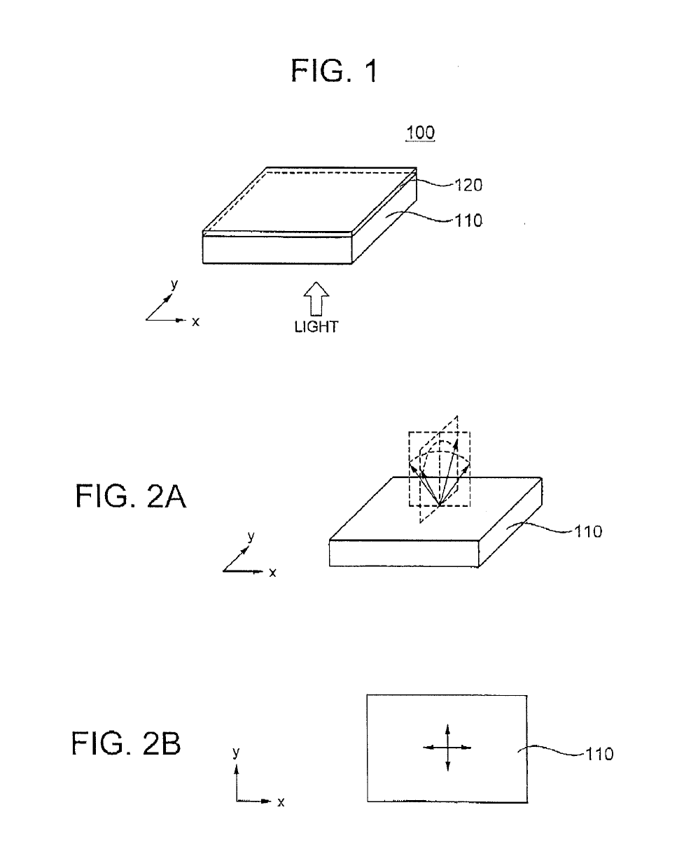

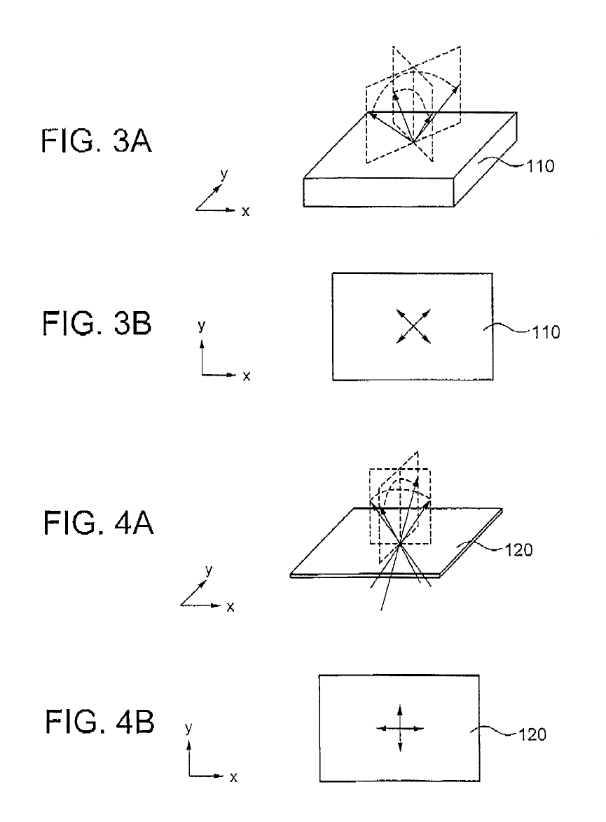

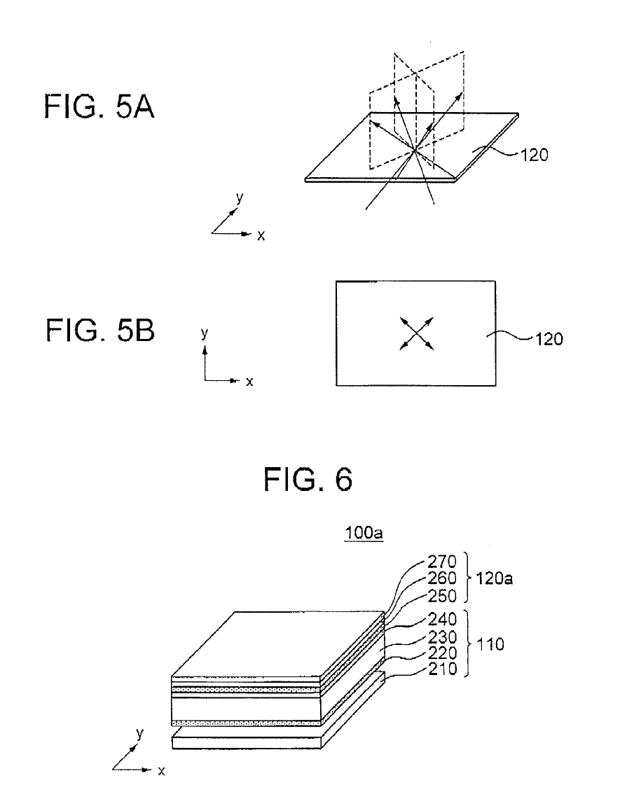

FIGS. 2A and 3A are perspective views of the display panel 110 of FIG. 1, as viewed in a slanted direction from above. FIGS. 2B and 3B are top plan views of the display panel 110, as viewed in the front view, i.e., in the direction normal to the display panel. FIGS. 4A and 5A are perspective views of the antidazzle film 1202 as viewed in a slanted direction from above. FIGS. 4B and 5B are top plan views of the antidazzle film 120, showing the film 120 as viewed in the front direction. These drawings show the definition of the azimuth direction and the azimuth direction dependency of the leakage light or the scattering of light.

FIGS. 2A and 2B show the azimuth directions of the LCD panel 100 in which the amount of leakage light is small upon display of the dark state, when the display panel 110 is observed in an slanted view. These azimuth directions coincide with the x- and y-directions. FIGS. 3A and 3B show the azimuth directions of the LCD, panel 110 in which the amount of leakage light is large upon display of the dark state, when the display panel 110 is observed in a slanted view. These directions are diagonal directions of the LCD panel 100, or 45 degree away from the x- and y-directions.

The antidazzle film 120 is disposed on the display panel 110 so that the directions in which the antidazzle film 120 has a largest scattering function coincide with the directions parallel to the longer sides and shorter sides of the display screen, as understood from FIGS. 4A and 4B. Thus, the amount of leakage light is a maximum in the directions deviated by 45degree away from the directions parallel to the longer sides and shorter sides of the display screen upon display of the dark state in the slanted view, and these directions are parallel to the directions in which the antidazzle film 120 has a weak light scattering function.

It is assumed here, in contrast to the above-described case, that the directions in which the amount of leakage light is maximum upon display of the dark state in the slanted view of the display panel 110 coincide with the directions parallel to the longer sides and shorter sides of the display screen, and that the directions in which the amount of leakage light is minimum upon display of the dark state in the slanted view of the display panel 110 coincide with the directions deviated by 45 degree away from the directions parallel to the longer sides and shorter sides of the display screen. In this case, it is sufficient that the antidazzle film 120 be disposed so that the directions in which the antidazzle film 120 has a strong light scattering function coincide with the directions deviated by 45 degree away from the directions parallel to the longer sides and shorter sides of the display screen, and so that the directions parallel to the longer sides and shorter sides of the display screen coincide with the direction in which the antidazzle film 120 has a weak light scattering function.

In the exemplary embodiment, the direction of the maximum leakage light coincides with the direction in which the antidazzle film 120 has a weak light scattering function. Thus, only a small part of the light incident onto the antidazzle film 120 in a slanted direction in which the leakage light is maximum in the display panel 110 is changed with respect to the traveling direction of light. Therefore, the antidazzle film 120 suppresses the decrease in the contrast ratio in the normal view, while suppressing the decrease in the visibility of image caused by the interference of the internal light of the LCD panel with the external light Hence, the display unit of the exemplary embodiment provides a higher contrast ratio and is superior in the image visibility.

Examples of the above embodiment will be described below.

### EXAMPLE 1

FIG. 6 is a perspective view of a display unit according to Example 1 of the above embodiment. The display unit, generally designated by reference sign 100a, according to this example includes a display panel 110 and an antidazzle film 120a formed thereon. The display panel 110 includes a LC cell 230, a pair of polarizing films 220 and 240, and a backlight unit 210. The LC cell 230 is interposed between the pair of polarizing films 220 and 240. The backlight 210 provides backlight to the LC cell 230 from the rear surface thereof through the polarizing film 220. The antidazzle film 120a has scattering control films 250 and 260 and a surface scattering film 270. Although not specifically shown in the figure, the LC cell 230 includes a pair of glass substrates and a LC layer sandwiched therebetween. The glass substrates are spaced apart from one another by a predetermined gap therebetween. The LC layer is received in the gap between the glass substrates. On one of the glass substrates, a thin-film transistor array is provided, which drive pixels, i.e., parts of the LC layer, in a pixel-by-pixel basis. On the other glass substrate, a color-filter layer is provided, which serves to display color images. The LC cell 230 is driven in an in-plane-switching mode which provides a higher viewing angle characteristic. Nonetheless, the LC cell 230 may be driven in any other driving mode, such as the vertical alignment mode that also provides a higher viewing angle characteristic and a higher contrast ratio in the normal direction, or the bend alignment mode that provides a higher viewing angle characteristic and a higher response characteristic. The LC cell 230 may be driven in the TN mode instead.

The polarizing films 220 and 240 are of the ordinary type including a pair of protective films made of triacetyl cellulose (TAC) and an iodine-containing polarizing film made of polyvinyl alcohol (PVA) and interposed between the protective films. That is, the polarizing films 220 and 240 absorb the polarized component oscillating in a specific direction referred to as light absorbing axis and allowing the polarized component oscillating in another specific direction intersecting at right angles with the light absorbing axis and referred to as light transmitting axis. The backlight unit 210 is of an ordinary type that includes a cold-cathode-ray tube and an optical guide plate made of acrylic resin.

The light scattering film 270 is of the type shown in JP-1984-18706A and JP-1998-20103A, and includes a transparent base layer and an antidazzle layer formed on the transparent base layer and having a concave-and-convex surface. The scattering-control films 250 and 260 are Lumistee films (trademark, manufactured by Sumitomo Chemical Co., Ltd.). Lumistee films appear transparent or frosted, depending on the viewing direction in which the films are observed. Lumistee films are generally used as view-field controlling films bonded onto plate glass. Lumistee films are also used to improve the viewing-angle characteristic of LCD units.

At present, four types of Lumistee films are available: one which appears opaque as viewed in the normal direction; two which appear opaque as viewed from one of the slanted viewing directions; and another which appears opaque as viewed from both the viewing directions. Of these types, Lumistee film MFX-1515 that appears opaque as viewed in the normal direction is used as the scattering control films 250 and 260. If the MFX-1515 is employed to use this view-field controlling function in the vertical direction, MFX-1515 will appear transparent when observed from the front, at any angle equal to or larger than 15 degrees in the vertical direction, and will appear opaque similarly to frosted glass when observed form the front, at any angle smaller than 15 degree in the vertical direction or when observed from laterally slanted directions. For simplicity of description, the direction in which this film appears opaque and thus nothing behind the film is observed is referred to as “scattering axis” in this text.

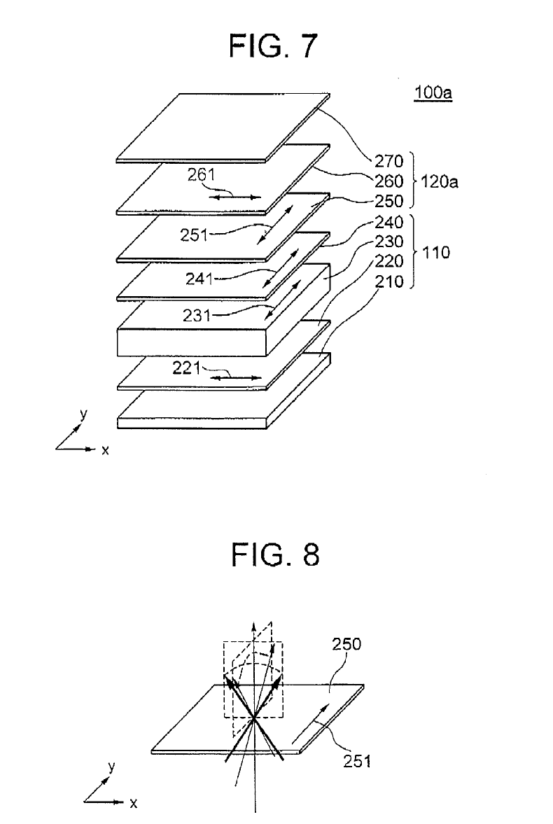

FIG. 7 is an exploded perspective view of the display unit 100a of FIG. 6, showing the light-absorbing axes 221 and 241 of the polarizing films 220 and 240, the initial orientation 231 of the LC cell 230, and the scattering axes 251 and 261 of the scattering control films 250 and 260. The polarizing films 220 and 240 are arranged so that their light-absorbing axes 221 and 241 intersect at right angles with each other. One of the light absorbing axes 221 and 241, i.e., light-absorbing axis 221 in the example of FIG. 7, extends along the longer side of the display screen, or parallel to the x-direction. The other of the light-absorbing axes 221 and 241 extends along the shorter side of the display screen, or parallel to the y-direction.

The initial orientation 231 of the LC cell 230 is parallel to one of the light-absorbing axes 221 and 241, i.e., parallel to the light-absorbing axis 241 in the example of FIG. 7. The scattering axes 251 and 261 of the scattering-control films 250 and 260 correspond to the azimuth directions in which the amount of leakage light is small upon display of the dark state when the image on the display panel 110 is observed in a slanted direction. The scattering axis of the one of the scattering-control films 250 and 260, i.e., scattering axis 251 in the example of FIG. 7, extends parallel to the y-direction. The other scattering axis, i.e., scattering axis 261 in the example of FIG. 7, extends parallel to the x-direction.

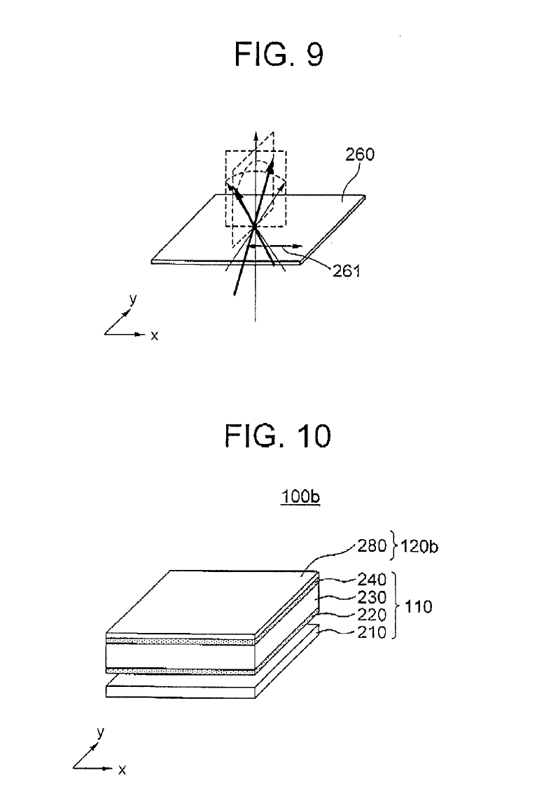

FIGS. 8 and 9 are schematic diagrams showing the scattering of light scattered by the scattering control films 250 and 260, respectively. Due to the scattering axis 251 parallel to the y-direction, the scattering control film 250 exhibits a stronger scattering function with respect to the light component which is incident onto the film 250 from the rear surface thereof in the normal direction or a slanted direction slanted parallel to the y-direction. This fact is represented by a thin arrow in FIG. 8. The scattering control film 250 also exhibits a weaker scattering function with respect to the other light component which is incident thereto in a slanted direction slanted parallel to the x-direction. This fact is represented by a thick arrow in PIG. 8.

Due to the scattering axis 261 parallel to the x-direction, the scattering control film 260 exhibits a stronger scattering function with respect to the light component which is incident onto the film 261 from the rear surface thereof in the normal direction or a slanted direction slanted parallel the x-direction. This fact is represented by a thin arrow in FIG. 9 The scattering control film 260 also exhibits a weaker scattering function with respect to the other light component which is incident onto the film 260 in a slanted direction slanted parallel to the y-direction. This fact is represented by a thick arrow in FIG. 9.

In the present example, the display panel 110 has the LC cell 230 in which each pixel is driven by a TFT in the in-plane switching mode. Therefore, the display unit 110a has a relatively superior viewing angle characteristic. An optical compensating layer may be interposed between the polarizing film 220 or 240 and the LC cell 230, to further improve the viewing angle characteristic. Even in this case, however, a larger amount of leakage light is observed in a slanted view slanted in the azimuth direction parallel to the diagonal direction of the display panel than in a slanted view slanted in the azimuth direction parallel to the longer or shorter sides of the display panel.

On the other hand, the antidazzle film 120a includes two scattering control films 250 and 260 and a surface scattering film 270, which are stacked one on another in this order, the scattering control films 250 and 260 having scattering axes parallel to the x-direction and the y-direction, respectively. The antidazzle film 120a has, due to function of the surface scattering film 270, an antidazzle function which is sufficient to suppress the glare and improves the visibility of images degraded by the interference of the internal light with the external light from the room windows or with the illumination light. The antidazzle film 120a also has, due to the function of the scattering control films 250 and 260, a scattering function which is sufficient to scatter the light incident thereto in the normal direction and in a slanted direction slanted in the azimuth directions parallel to the x- and y-directions. Thus, the antidazzle film 120a suppresses the occurrence of scintillation upon displaying a high-definition image on the display panel 110.

An important property of the antidazzle film 120a is that the scattering function is weaker with respect to the light in the azimuth direction parallel to the diagonal directions of the display screen, in which the amount of leakage light is maximum in a slanted view upon display of the dark state than with respect to the light in the azimuth direction parallel to the longer and shorter sides of the display screen. This property prevents the leakage light among the light passed by the display screen in the diagonal directions from being changed in the direction thereof toward the normal direction, thereby providing a display unit having a higher contrast ratio and an excellent visibility.

### EXAMPLE 2

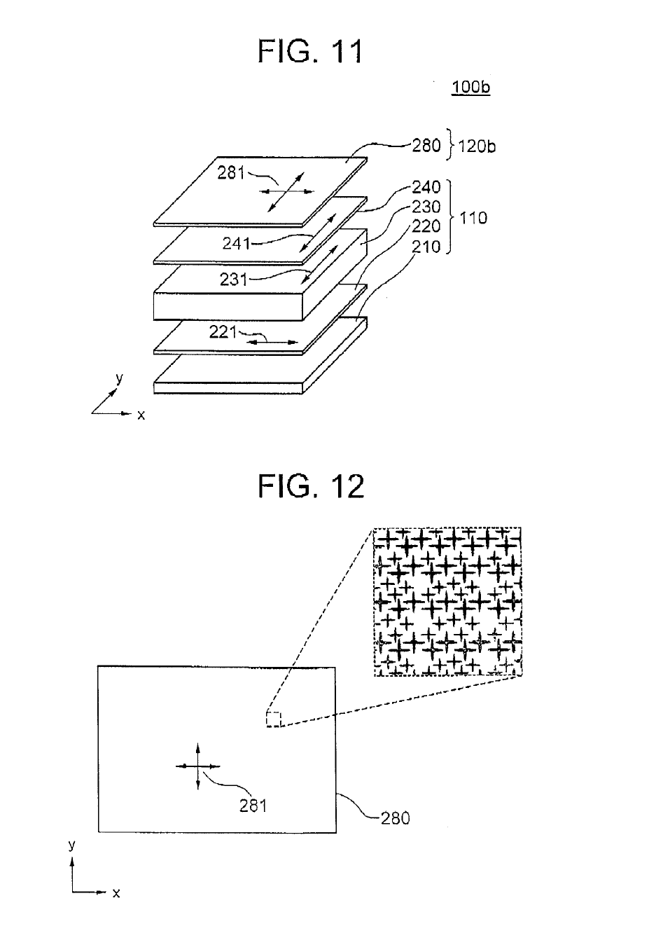

FIG. 10 is a perspective view showing a display unit according to a second example of the above embodiment, and FIG. 11 is an exploded perspective view of the display unit of FIG. 10. In FIG. 11, the display unit, generally designated by reference sign 100b, includes a display panel 110 including polarizing films 220 and 240 having light-absorbing axes 221 and 241, and a LC cell 230 having an initial orientation 231, which are similar to those in Example 1 shown in FIG. 7. In this example, the antidazzle film 120b includes no scattering control film 250 or 260 shown in FIG. 6, such as configured by Lumistee film. The antidazzle film 120b includes no underlying scattering film such as described in JP-2001-91707A. The antidazzle film 120b includes a surface scattering film 280 having an antidazzle function attained by a concave-and-convex surface thereof.

Similarly to the scattering film described in JP-6-18706A or JP-10-20103A, the surface scattering film 280 includes a transparent base layer and an antidazzle film formed on the base layer and having a concave-and-convex surface. In this example, the concave portions and convex portions are arranged not at random. Rather, the concave portions and convex portions of different sizes are arranged such that the surface scattering film 280 has anisotropy with respect to directions of light in the scattering function. FIG. 12 is a top plan view of the concave-and-convex surface of the surface scattering film 280, attached with a magnified figure illustrating the detail of the representative pattern formed in a portion thereof. In FIG. 12, the convex portions are depicted by dark figures each of which has extensions or projections extending in the x- and y-directions or parallel to the longer and shorter sides of the display screen. Those extensions provide anisotropic scattering function for the surface scattering film 280. In an alternative, the dark figures shown in FIG. 12 may show the shape of the concave portions.

The concave-and-convex surface of the surface scattering film 280 may be formed by, for example, embossing, by transferring embossed pattern formed on a plate to the surface of a film to configure the surface scattering film 280. In an alternative, the pattern may be formed by a photolithographic process including the steps of forming a photoresist film on a base material, exposing the photoresist film, and developing the photoresist film to have the pattern. In another alternative, the pattern may be formed by grinding the surface of a film in specific directions, forming small scratches on the surface. The concave-and-convex pattern formed by one of the above techniques may be heated for partially melting the pattern, and then immersed in a solvent, exposed to the atmosphere of a solvent, or coated with resin, to thereby smooth the lo concave-and-convex surface of the pattern.

In the antidazzle film 120b, the pattern of the concave-and-convex surface has specific directions denoted by numeral 281. The specific directions coincide with the directions of the longer and shorter sides of the display screen, in which the amount of leakage light is small upon display of the dark state when observed in a slanted view. This configuration allows the light incident in the diagonal directions of the display screen to be scattered in a smaller amount as compared to the light incident in the directions parallel to the longer and shorter sides of the display screen. The unit size of the concave and convex portions on the surface scattering film 280 may be selected well smaller than the pitch or size of the pixels of the display unit, in order to suppress the phenomenon known as scintillation.

As described above, the specific directions of the surface scattering film 280 coincide with the directions of the longer and shorter sides of the display screen, in which the amount of leakage light is small upon display of the dark state when observed in a slanted view. By reducing the scattered amount of light incident in the directions in which the amount of leakage light is large upon display of the dark state, the amount of light, which is scattered by the antidazzle film 120b and thus changed in the directions toward the normal direction, can be reduced. Thus, the display unit 100b has a higher contrast ratio and an excellent visibility as in the case of Example 1.

### EXAMPLE 3

Example 3 is similar to Example 1 except that the antidazzle film 120 (FIG. 7) used in Example 1 is replaced by the surface scattering film 280 (FIG. 11) used in Example 2 and having anisotropy in the scattering function of the concave-and-convex surface. Also in this example, the light incident in the directions in which the amount of leakage light is a maximum upon display of the dark state in a slanted view is scattered in a smaller amount, similarly to Examples 1 and 2. Thus, Example 3 also provides a display unit having a higher contrast ratio and a higher visibility.

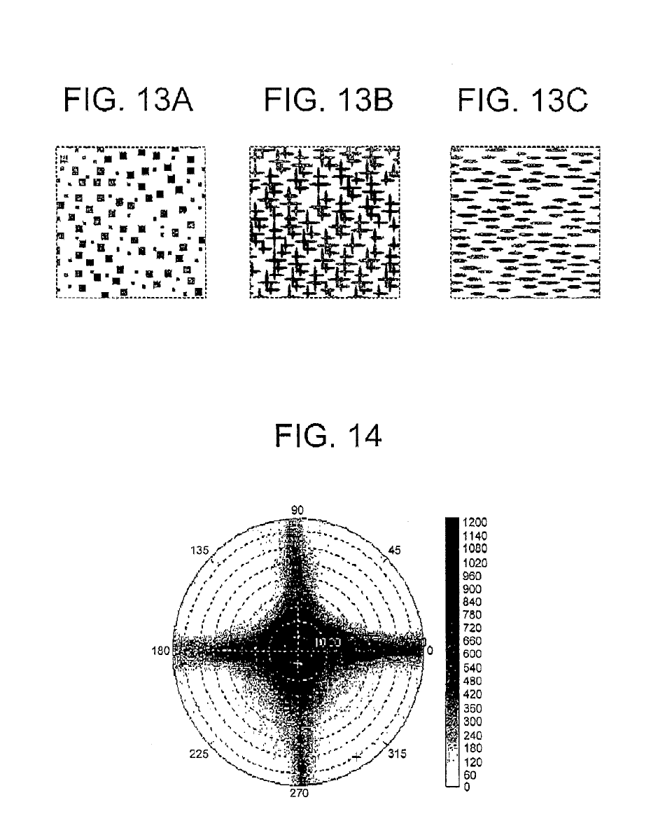

It is to be noted that although the pattern shown in FIG. 12 is used as an anisotropic pattern having an anisotropic scattering property in Example 2, the concave-and-convex pattern is not limited to that shown in FIG. 12B. FIGS. 13A to 13C show other examples of the pattern that may be formed on the surface scattering film 280. In these examples, the dark figures represent convex portions, and the density or gradation shows the height of the convex portions. In the example of FIGS. 13A and 13B, the convex patterns have projections parallel to both the longer and shorter sides of the display screen, whereas in the example of FIG. 13C, the convex patterns have projections parallel to the longer sides of the display screen. That is, the patterns need not have anisotropy in both the directions parallel to the longer and shorter sides of the display screen. If the surface scattering film 280 is required to scatter the light only in one direction, the surface scattering film 28 may have anisotropic scattering property in one direction parallel to the longer sides of the display screen.

As described heretofore, in the display unit of the above exemplary embodiment, the antidazzle film has anisotropy in the scattering function with respect to the azimuth direction of the light in which the incident light is slanted with respect to the normal direction of the display screen. The anisotropy of the surface scattering film is such that the azimuth direction in which the antidazzle film has a stronger scattering function substantially coincides with the direction in which the leakage light is small upon display of the dark state when the display unit is observed in a slanted view. This suppresses the light incident onto the surface scattering film in a slanted direction from being scattered and changed in the direction thereof toward the normal direction of the display unit. Thus, a display unit having a higher contrast ratio and a higher visibility can be achieved.

The antidazzle layer 120 as described heretofore may be combined with the polarization film 240. In this configuration the optical polarizing film includes: a polarizing layer, such as 240 shown in FIG. 10, having a light transmission axis and a light absorbing axis perpendicular to one another: and an antidazzle film, such as 120b shown in FIG. 10, that scatters incident light and has a higher scattering function with respect to light incident in a first azimuth direction than with respect to light incident in another azimuth direction, wherein the first azimuth direction substantially coincides with the light transmission axis or the light absorbing axis.

As described heretofore, the present invention may have the following exemplary embodiments:

The display panel may include a liquid crystal cell and an optical polarization film, and the second azimuth direction substantially coincides with an azimuth direction of a light absorbing axis or a light transmission axis of the optical polarization film.

The liquid crystal cell may be driven by a lateral electric field, driven in a vertical orientation mode, driven in a bend orientation mode, or driven in a twisted nematic mode.

The antidazzle film may include a scattering control film having anisotropy with respect to an azimuth direction of incident light and a surface scattering film having a concave-and-convex surface, which are layered one on another.

The surface scattering film may have concave portions and convex portions, the concave portions and/or the convex portions having anisotropy in the shape thereof.

The antidazzle film may include a surface scattering film having concave portions and convex portions, the concave portions and/or the convex portions having anisotropy in the shape thereof.

The concave portions and/or the convex portions may have the anisotropy in a direction parallel to at least one of the light absorbing axis and the light transmission axis.

While the invention has been particularly shown and described with reference to exemplary embodiments thereof, the invention is not limited to these embodiments It will be understood by those of ordinary skill in the art that various changes in form and details be made therein without departing from the spirit and scope of the present invention as defined in the claims

1. A display unit comprising:
a display panel having a property wherein an amount of leakage light upon display of a dark state is smaller in a slanted view slanted in a first azimuth direction than in a slanted view slanted in another azimuth direction; and
an antidazzle film that scatters incident light and has a higher scattering function with respect to light incident in a second azimuth direction than with respect to light incident in another azimuth direction,
wherein said first azimuth direction substantially coincides with said second azimuth direction.

2. The display unit according to claim 1, wherein said display panel includes a liquid crystal cell and an optical polarization film, and said second azimuth direction substantially coincides with an azimuth direction of a light absorbing axis or a light transmission axis of said optical polarization film.

3. The display unit according to claim 2, wherein said liquid crystal cell is driven by a lateral electric field.

4. The display unit according to claim 2, wherein said liquid crystal cell is driven in a vertical orientation mode.

5. The display unit according to claim 2, wherein said liquid crystal cell is driven in a bend orientation mode.

6. The display unit according to claim 2, wherein said liquid crystal cell is driven in a twisted nematic mode.

7. The display unit according to claim 1, wherein said antidazzle film includes a scattering control film having anisotropy with respect to an azimuth direction of incident light and a surface scattering film having a concave-and-convex surface, which are layered one on another.

8. The display unit according to claim 7, wherein said surface scattering film has concave portions and convex portions, said concave portions and/or said convex portions having anisotropy in the shape thereof.

9. The display unit according to claim 2, wherein said antidazzle film includes a surface scattering film having concave portions and convex portions, said concave portions and/or said convex portions having anisotropy in the shape thereof.

10. The display unit according to claim 9, wherein said concave portions and/or said convex portions have said anisotropy in a direction parallel to at least one of said light absorbing axis and said light transmission axis.

11. An optical polarization film comprising:
a polarizing layer having a light transmission axis and a light absorbing axis perpendicular to one another: and
an antidazzle film that scatters incident light and has a higher scattering function with respect to light incident in a first azimuth direction than with respect to light incident in another azimuth direction,
said first azimuth direction substantially coincides with said light transmission axis or said light absorbing axis.

12. The optical polarization film according to claim 11, wherein said antidazzle film includes a scattering control film having anisotropy with respect to an azimuth direction of incident light and a surface scattering film having a concave-and-convex surface.

13. The optical polarization film according to claim 12, wherein said surface scattering film has concave portions and convex portions, said concave portions and/or said convex portions having anisotropy in the shape thereof.

14. The optical polarization film according to claim 11, wherein said antidazzle film includes a surface scattering film having concave portions and convex portions, said concave portions and/or said convex portions having anisotropy in the shape thereof.

15. The optical polarization film according to claim 14, wherein said concave portions and/or said convex portions have said anisotropy in a direction parallel to at least one of said light absorbing axis and said light transmission axis.

16. An antidazzle film comprising:
a scattering control film having anisotropy with respect to an azimuth direction of incident light; and
a surface scattering film having a concave-and-convex surface,
wherein said antidazzle film has a higher scattering function with respect to light incident in an azimuth direction than with respect to light incident in another azimuth direction

17. The antidazzle film according to claim 16, wherein said antidazzle film has a concave-and-convex surface, said concave portions and/or said convex portions having anisotropy in the shape thereof.

18. A method for manufacturing an antidazzle film, comprising:
transferring a pattern having concave portions and convex portions onto a film by using an embossing technique to form the antidazzle film having concave portions and convex portions, said concave portions and/or said convex portions having anisotropy in the shape thereof.

19. A method for manufacturing an antidazzle film, comprising:
forming a photoresist film on a base film, exposing the photoresist film by using an exposure mask, and developing the exposed photoresist film, to form the antidazzle film having concave portions and convex portions, said concave portions and/or said convex portions having anisotropy in the shape thereof.

20. A method for manufacturing an antidazzle film, comprising:
forming a photoresist film on a base film, exposing the photoresist film by using an exposure mask, developing the exposed photoresist film, and melting the developed photoresist film, to form the antidazzle film having concave portions arid convex portions, said concave portions and/or said convex portions having anisotropy in the shape thereof.

21. The method according to claim 18, wherein said concave portions and/or said convex portions have said anisotropy in a direction parallel to at least one of said light absorbing axis and said light transmission axis.

22. The method according to claim 19, wherein said concave portions and/or said convex portions have said anisotropy in a direction parallel to at least one of said light absorbing axis and said light transmission axis.

23. The method according to claim 20, wherein said concave portions and/or said convex portions have said anisotropy in a direction parallel to at least one of said light absorbing axis and said light transmission axis.
